(19) United States
(12) Patent Application Publication
(10) Pub. No.: US 2019/0331754 A1
(43) Pub. Date: Oct. 31, 2019

(54) LOCATION SYSTEM FOR MARITIME BEACON AND ASSOCIATED METHODS

(71) Applicant: MetOcean Telematics Limited, Dartmouth (CA)

(72) Inventors: Anthony George Chedrawy, Dartmouth (CA); Scott Robert Ashley Ivany, Dartmouth (CA); Scott Kendall Feener, Dartmouth (CA); Christopher Francis Brake, Dartmouth (CA); David Andrew Steele, Dartmouth (CA)

(73) Assignee: MetOcean Telematics Limited, Dartmouth (CA)

(21) Appl. No.: 16/144,929

(22) Filed: Sep. 27, 2018

Related U.S. Application Data
(60) Provisional application No. 62/664,391, filed on Apr. 30, 2018.

(51) Int. Cl. G01S 1/08; G01S 5/02; G06F 9/54; H04W 4/029; H04W 4/02

(52) U.S. Cl. CPC G01S 1/08; G01S 5/0242; H04W 4/025; G06F 9/542; H04W 4/029; G01S 5/0231

(57) ABSTRACT

A maritime beacon includes a controller and multiple communications systems including a bidirectional communications transceiver and a broadcast alert signal generator. The beacon uses the bidirectional communications transceiver to communicate with a remote computer and the broadcast alert signal generator to communicate with recovery vessels in the vicinity. This may allow the local broadcast alert signal generator to be remotely controlled to better facilitate recovery of the beacon and associated assets.

### FIELD

The present disclosure relates to beacons. In particular, a beacon is an electronic device that may be used to assist in the location, tracking, monitoring and recovery of underwater assets and oceanographic equipment.

### BACKGROUND

Beacons may be used to track assets. Examples of Assets include; scientific and oceanographic instruments, ROVs (Remote Operated Vehicles), OBSs (Ocean Bottom Seismic Systems), Military Instruments and equipment, Buoys, Aids to Navigation, Emergency Beacons, Vessels, Shore Stations, and so on. Beacons may include a light, a power source, GPS, and a communication radio. It will be appreciated that these devices may be used to locate the beacon. For example, the communication radio or light may be used by nearby vessels to locate the beacon.

GB 2,368,489 (Dunkin) relates to a radio frequency system for remote location of one or more movable entities such as skiers buried in avalanches, lost hikers or climbers or any other object that needs to be located e.g. animals, vehicles. More particularly, a transmitter/receiver located with the entity uses intermittent reception and triggered transmission to extend battery lifetime and enable the use of smaller batteries. The system comprises a portable unit and a search unit, each having a transmitter portion and a receiver portion. The portable unit is adapted to be carried by the entity and the receiver portion of the portable unit normally operates intermittently, e.g. 10 milliseconds per second. The search unit is able to transmit a coded signal and if the portable unit, during operation, receives a coded signal that it recognizes, i.e. its own code, it is triggered to respond by actuating its transmitter to transmit a unique coded signal for a predetermined period of time. The search unit is able to receive this signal.

U.S. Pat. No. 4,763,126 (Jawetz) discloses a buoy for marine vessels that is responsive to a transmitted RF signal of a set frequency consisting of an RF receiver disposed within the buoy and tuned to a set frequency of the transmitted RF signal and an antenna coupled to the input of the RF receiver. A switching circuit is coupled to the RF receiver, and a lamp is disposed on the buoy so that when the RF receiver receives a signal at the set frequency, it will operate said switching circuit and turn on said lamp. The lamp can also be mounted on the end of the antenna. A sound source coupled to the output of the switching circuit can sound an audible signal in response to the transmitted RF signal.

U.S. Pat. No. 4,903,243 (Turner) discloses a marine transponder system which is selectively activated to produce a predetermined signal pattern of light/sound/radio transmissions for maritime devices. A remote transmitter is used to broadcast an uncoded or coded signal at a predetermined frequency to activate the marine transponder system. The transponder system includes an RF receiver tuned to the predetermined frequency, and optionally a decoder unit for verifying the coded signal. Upon receipt of the transmitted frequency signal, the transponder system causes an omni-directional light/sound/radio source to be energized to produce the predetermined signal pattern.

U.S. Pat. No. 5,754,136 (Kojima et al.) discloses a rescue aiding apparatus carried by a lost person includes a radio receiver for receiving a radio signal, a radio transmitter for transmitting a radio signal, and a power supply for supplying working power. When the radio receiver receives a radio search signal transmitted from a search party, the power supply supplies operating power to the radio transmitter. The apparatus thereby becomes fully operable, and the radio transmitter transmits a radio signal as a response signal for enabling a search for the lost person needing protection.

U.S. Pat. No. 5,929,777 (Reynolds) discloses a personal infrared beacon unit capable of being worn as an adornment of clothing, incorporated into a part of a person's attire, or embodied within a personal pager, a cellular phone or a 2-way data device. The beacon unit may be in communication with an established network and may be activated externally by a locator signal, or internally by activation of an emergency button. Upon activation, the beacon unit emits coded timed infrared bursts in coherent beams, and when the beams are detected, they may be decoded visually or with a decoding device to provide the identity and location of the user.

U.S. Pat. No. 7,969,822 (Basilico) discloses a location reference unit which includes a receiver to receive navigation signals from earth-orbiting satellites and/or an inertial navigation system. The location reference unit further includes control circuits to communicate with to sub-surface beacon units and to transmit location information to said sub-surface beacon units, and a transceiver to transmit location information to the subsurface beacon units.

U.S. Pat. No. 8,041,330 (Garin) discloses a wireless device capable of producing an emergency beacon signal is disclosed. The wireless device has a radio portion and may include a beacon transmitter and a controller in signal communication with the radio portion and beacon transmitter. The controller is capable of instructing the beacon transmitter to transmit a beacon location signal in response to the radio portion receiving a beacon activation signal. The wireless device may further include a satellite position system (“SPS”) receiver in signal communication with the controller.

U.S. Pat. No. 9,643,688 (Waldrop) discloses a remote controlled lighted mooring beacon. An electronics package is located on the shaft including a receiver that responds to a wireless code for generating an activation signal. A 360 degree viewable high intensity light source is on top of the shaft, is daylight visible and is activated by the actuation.

US 2007/0064525 (Sanders et al.) discloses a marine transponder comprising a position module, a satellite uplink module and a microcontroller, the microcontroller being operable at intervals to activate the position module for providing a location reading and to activate the satellite uplink module for transmission of the location reading and an identifying code.

US 2011/0121734 (Pape) discloses a beacon for use at transportation hubs, such as airports, heliports, and marine vessels. The beacon comprises a reflector and a light source, such as a light emitting diode (LED) or an array of LEDs, are mounted in the cavity of the housing. The beacon includes a control unit with a GPS transceiver unit and another control inlet/outlet.

WO2007/110512 (Pierron) discloses comprising a buoy, said buoy comprising: electronic signal processing means and a transmitter of signals able to transmit some of said processed signals to a communication satellite in orbit around the earth. The buoy also comprises a receiver of signals transmitted by ships located in a navigation area around the buoy. That is, the buoy can bidirectionally communicate with the satellite.

WO2013/057346 (Martinez et al.) discloses a buoy having parameter-measuring sensors and a GPS receiver for storing data in a first file which is segmented into packets of a maximum length defined by the SBD Iridium protocol for the subsequent sending thereof to the base station.

### SUMMARY

In accordance with the disclosure, there is provided a maritime beacon comprising:

a controller;

a bidirectional communications transceiver in communication with the controller;

a broadcast alert signal generator in communication with the controller;

wherein the controller is configured:

to communicate with a remote computer via the bidirectional communications transceiver to transmit notifications to, and to receive configuration commands from, the remote computer; and

to control the operation of the broadcast alert signal generator based on the received configuration commands.

The broadcast alert signal generator may comprise a broadcast antenna configured to broadcast location information.

The configuration commands may be configured to control one or more of

when the broadcast antenna is activated;

when the broadcast antenna is deactivated; and

the rate of recurrence of broadcasting location information.

The bidirectional communication transceiver may be configured to transmit information to a remote device in response to the maritime beacon resurfacing after having been underwater. It will be appreciated that the beacon (e.g. controller) may be configured to prevent the bidirectional communication transceiver and/or broadcast alert signal generator being activated while the beacon is underwater.

The beacon may be configured to detect when it reaches the surface using a surface detector.

The broadcast alert signal generator may be configured to generate audiovisual alerts signals.

The configuration commands may be configured to control the broadcast alert signal generator to emit signals in a particular pattern.

The bidirectional communications transceiver may be configured to use satellite communications.

The broadcast antenna may be configured to transmit automatic identification system (AIS) information.

The broadcast antenna may be configured to broadcast radio waves.

The broadcast antenna may be configured to be activated in a predetermined default mode in response to determining that the bidirectional communications transceiver is unresponsive.

The beacon may comprise a location system for determining the beacon location based on signals received from a satellite-based positioning system.

The beacon may comprise a battery or a power source connector configured to connect to an external power source.

The beacon may comprise a renewable power source.

The beacon may be configured to transmit an ID to the remote computer via the bidirectional communications transceiver.

The beacon may be configured to transmit location information to the remote computer via the bidirectional communications transceiver.

The beacon may be a submersible beacon.

According to a further aspect, there is provided a method for operating a maritime beacon having a bidirectional communications transceiver and a broadcast alert signal generator, the method comprising:

receiving configuration commands via the bidirectional communications transceiver; and

controlling the operation of the broadcast alert signal generator based on the received configuration commands.

According to a further aspect, there is provided a system comprising:

one or more beacons described herein; and

a remote computer, wherein the remote computer is configured to receive information from a said bidirectional communications transceiver and to transmit configuration commands to a said beacon.

According to a further aspect, there is provided a communications computer comprising:

a controller;

a bidirectional communications transceiver in communication with the controller;

wherein the controller is configured:
to communicate with a maritime beacon via the bidirectional communications transceiver to receive notifications from, and to transmit configuration commands to, the maritime beacon; and
to control the operation of a broadcast alert signal generator of the maritime beacon using the transmitted configuration commands.

The beacons may be configured to communicate by one or more methods including one or more of the following:

Xenon Flashing Light (Visual)

LED Flashing Light (Visual)

GPS Satellite Communication (Location Radio)

VHF/UHF Radio Locating System (Communication Radio)

Iridium Satellite Radio (bi-directional) (Communication Radio)

Other Communication Radios:

AIS (automatic identification system)

LRIT (Long-range identification and tracking)

Cellular, including 5G (for near shore)

Underwater Acoustics

Modulated Radar

The beacons may comprise one or more of the following power sources:

Internal Battery, (e.g. Internal to the Beacon)

Alkaline Battery

Lithium Battery

Rechargeable Lithium Battery

External power source

Wired with Power from an External Power Pack

Wired with Power from the Host Asset.

Renewable energy source.

Wave energy power source

solar panels

wind energy power source

The beacon may be powered by an internal battery pack of non-rechargeable alkaline or lithium batteries, which may also be available in rechargeable form, or externally powered by the device (asset) that they are attached to. The beacon may be a self-contained unit configured to allow them to achieve depths of up to 7,300 m (24,000 feet) or beyond. Other beacons may be configured to achieve depths of up to 6,000 m and/or greater than 3000 m. The beacon may use a sealed pressure-rated pluggable electrical connector (e.g. a 7000 m rated SubConn® connector for transmitting power).

The beacon may comprise a glass dome sealed to the hull or body of the beacon. The seal may use a direct glass to metal seal with grease to fill in the surface asperities of the two mating surfaces. The bidirectional communications transceiver and/or the broadcast alert signal generator may be housed within the dome. The dome may be configured to provide a pressure resistant window to allow the bidirectional communications transceiver and/or the broadcast alert signal generator to transmit and receive signals.

The broadcast alert signal generator may or may not be configured to receive information. For example, the broadcast alert signal generator may be configured to transmit AIS information but not to receive AIS information from nearby vessels.

The broadcast alert signal generator and the bidirectional communications transceiver may be configured to transmit data. Some data transmitted by the broadcast alert signal generator and the bidirectional communications transceiver may be the same. For example, both the broadcast alert signal generator and the bidirectional communications transceiver may be configured to transmit a beacon ID and/or the beacon location.

The bidirectional communications transceiver may be configured to communicate via a satellite. The frequency of satellite communications may be between 20 MHz and 30 GHz (e.g. 406 MHz). Preferred frequency for satellite is ‘L Band’ (around 1 to 2 GHz) and for the broadcast radio ‘UHF’ (Ultra High Frequency—around 300 MHz to 3 GHz).

The beacon may include a light and/or a speaker. The beacon may include two communications radios for example, AIS and Iridium. The AIS broadcast antenna may be configured to use AIS.

At least one of the communications radios may allow bi-directional communications to the beacon. As noted above, the bi-directional capability of the bidirectional transceiver (e.g. Iridium) may be used to communicate with and/or control the AIS operation.

The beacon may be configured to periodically update the remote computer by repeatedly transmitting updated location information via the bi-directional communications transceiver. This may help the remote computer to direct vessels to within the range of the beacon broadcast antenna as the beacon may drift with time.

The bi-directional communications transceiver may be configured to communicate using a satellite based system such as Iridium, Global Star, Inmarsat, Thuraya, Arabsat, Orbcomm, Intelsat, Eutelsat, Cobham, ViaSat, Hispasa or CLS/Argos.

Another application of the bi-directional capability may be where a light (e.g. LED) component of the system can be communicated with and controlled for desired flash broadcast sequences.

Another application of the bi-directional capability may be that the user controls the operation of the bi-directional communications transceiver based on the received configuration commands. That is, depending on the circumstances, the user may elect not to use the broadcast signal generator but instead configure the bi-directional communications transceiver to send regular updates of location information. For example, this mode may be used if there are lots of other vessels in the area and the user is concerned that the asset may be identified or recovered by another vessel not associated with the legitimate user. Or if the nearest vessel does not have the required equipment to detect the broadcast signal but is configured to receive information from the bi-directional communications transceiver (e.g. via the remote computer or otherwise).

The bi-directional transceiver may be used to communicate with the beacon and/or an asset attached to the beacon to allow a remote computer to update status information. For example, the bidirectional transceiver and the controller may be configured to allow the remote computer to synchronize the time and date, update memory, perform a software update, and/or check the status of the asset and/or beacon. This may be particularly important for beacons or assets which are submerged for extended periods of time and may not have been in communication with an external information source for some time.

The AIS information may be broadcast when it surfaces. Typically, AIS resends updated information at known intervals. The beacon may be configured to take that updated AIS information and resend it on the alternate Iridium channel and/or the AIS transmitter.

An AIS antenna transceiver may work in an autonomous and continuous mode, regardless of whether it is operating in the open seas or coastal or inland areas. AIS antenna transceivers may use two different frequencies, VHF maritime channels 87B (161.975 MHz) and 88B (162.025 MHz), and use 9.6 kbits Gaussian minimum shift keying (GMSK) modulation over 25 kHz channels using the High-level Data Link Control (HDLC) packet protocol. Although only one radio channel is necessary, each station may transmit and receives over two radio channels to avoid interference problems, and to allow channels to be shifted without communications loss from other ships. The system may provide for automatic contention resolution between itself and other stations. Broadcast radio frequencies may be between 200 kHz-200 MHz.

The beacon may be configurable. For example, the beacon may offer several locating technologies or communication channels in a single device (LED flasher, GPS, Iridium and AIS). This may give the user the ability to choose light source, power means, GPS, and choose of one or two communications radios.

It will be appreciated that the beacon may be a single unit with multiple communications radio technologies.

The beacon may be configured to autonomously initiate its communication to the owner/crew on its own, using surface detection technology, rather than by receiving a Wake Up transmission from search and rescue crews.

The beacon may be configured to perform a surface check periodically to confirm it is still underwater. While it is underwater this check will result in the device maintaining an underwater mode. If this check results in determining that it is at surface, the beacon may be configured to activate a surface mode which may include transmitting information to a remote computer using the bidirectional transceiver.

Once communication is initiated after Surface Detection, then there may be structured (vs. automatic and manual) communications using the Bidirectional Radio so that the controller gets further instructions on what to do with the lights (audiovisual) and/or Broadcast Radio (AIS) in order to save battery power and to notify the authorized Crew of its location. In addition, it may be able receive configuration commands which may include various Go-to-Sleep and Wake Up Modes while following a built-in default protocol, a newly downloaded protocol from the user or on-demand upon receiving a signal from the user.

The term “rate of recurrence” has generally been used below in relation to how often information is transmitted. The term “frequency” has been generally used below in relation to parameters associated with radio waves (e.g. radio wave frequency given in MHz).

The remote computer may be a single computer or a collection of computers in communication with each other (e.g. via a network).

According to a further aspect of the disclosed technology, there is provided a computer program for operating a maritime beacon having a bidirectional communications transceiver and a broadcast alert signal generator, the computer program configured, when run on an appropriate processor, to:

enable reception of configuration commands via the bidirectional communications transceiver; and

control the operation of the broadcast alert signal generator based on the received configuration commands.

The computer program may be stored in a non-transitory medium such as a CD, DVD, USB or Cloud-based service.

The bidirectional communications transceiver may communicate with the remote computer via a gateway. A gateway may be a piece of networking hardware. The gateway may be a network node equipped for interfacing with another network that uses different protocols. A gateway may contain devices such as protocol translators, impedance matching devices, rate converters, fault isolators, or signal translators as necessary to provide system interoperability. It also requires the establishment of mutually acceptable administrative procedures between both networks.

A gateway may be configured to interconnect networks with different network protocol technologies by performing the required protocol conversions.

### BRIEF DESCRIPTION OF THE DRAWINGS

Various objects, features and advantages of the disclosed technology will be apparent from the following description of particular embodiments, as illustrated in the accompanying drawings. The drawings are not necessarily to scale, emphasis instead being placed upon illustrating the principles of various embodiments of the technology. Similar reference numerals indicate similar components.

FIG. 1a is a schematic view showing the various components of a beacon.

FIG. 1b is a side view of the beacon of FIG. 1a attached to a submerged underwater asset.

FIG. 1c is a side view of the beacon when it has resurfaced and is in communication with location and communications satellites.

FIG. 1d is a view from the remote computer of the received information from the resurfaced beacon and from other vessels in the vicinity.

FIG. 1e is a side view of the resurfaced beacon when it has received configuration commands from the remote computer and is broadcasting signals to facilitate recovery by a vessel in the vicinity.

FIG. 2 is a flow chart showing the process used by an embodiment of a beacon.

### DETAILED DESCRIPTION

### Introduction

Existing beacons may have one, two or three communications means. Typically this is a Light, GPS and a Radio Communication choice. Light Source (Xenon or LED) and/or GPS Radio and/or other Radio (VHF or Iridium). However these communication means may operate independently of each other.

One issue around beacons is that submersible beacons may have an unplanned resurface when there is no authorized vessel in the vicinity. This may be a problem particularly when the asset may have been submerged in very deep ocean water for several years before coming to the surface.

The data collection project of the asset could be invalidated and time and money lost if the asset is not received. This can happen if the beacon runs out of power before a vessel can arrive to retrieve the beacon and/or the asset to which the beacon is attached or otherwise associated. In addition, beacons configured to emit broadcast signals may be identified by third-party vessels which leads to a risk that valuable beacons and/or assets can be stolen if they simply broadcast their location widely when the owner's vessel is not in the vicinity. Therefore, the inventors have realized that there is a need for a beacon which can control how information is broadcast. This may help ensure that power is conserved and that information is only broadcast when there is a friendly vessel in the vicinity.

The following description includes embodiments of submersible beacons (7,300 m) that can be communicated with by more than one radio means when it is back at the surface so they have a choice on which to employ. This helps ensure that if one communication method becomes defective others are available when trying to recover these expensive and important assets.

Various aspects of the technology will now be described with reference to the figures. For the purposes of illustration, components depicted in the figures are not necessarily drawn to scale. Instead, emphasis is placed on highlighting the various contributions of the components to the functionality of various aspects of the technology. A number of possible alternative features are introduced during the course of this description. It is to be understood that, according to the knowledge and judgment of persons skilled in the art, such alternative features may be substituted in various combinations to arrive at different embodiments of the technology.

### Maritime Beacon Example

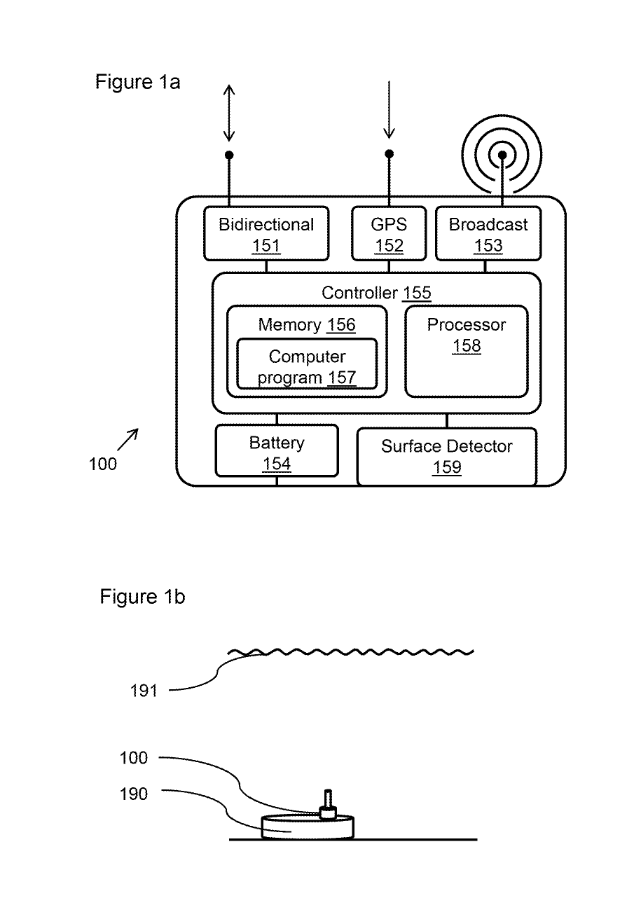

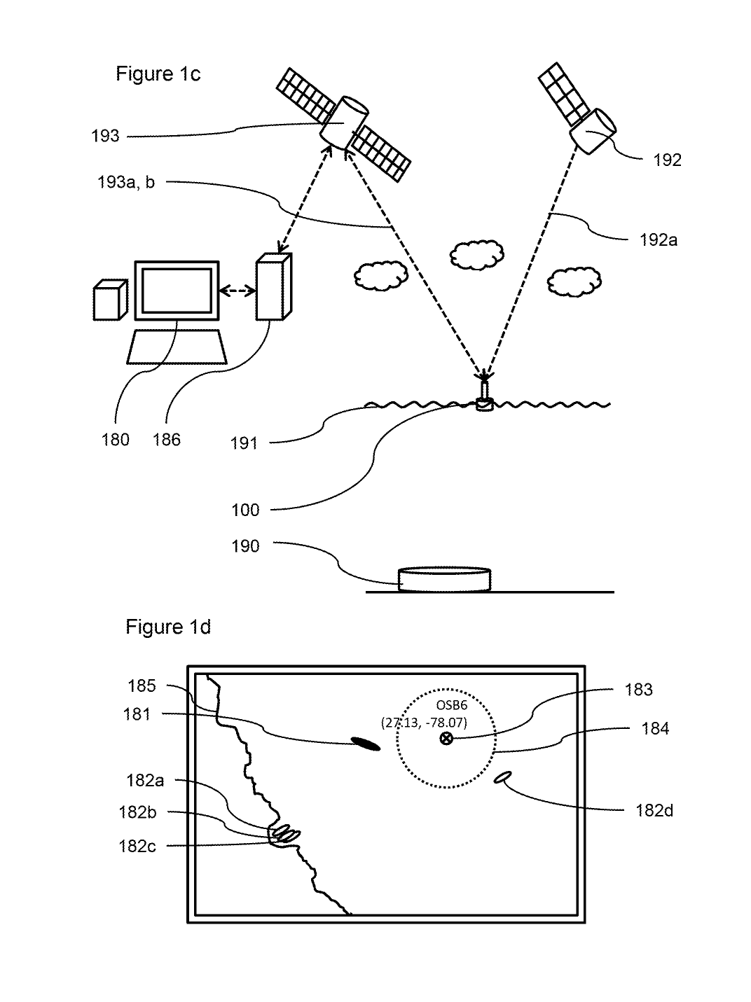

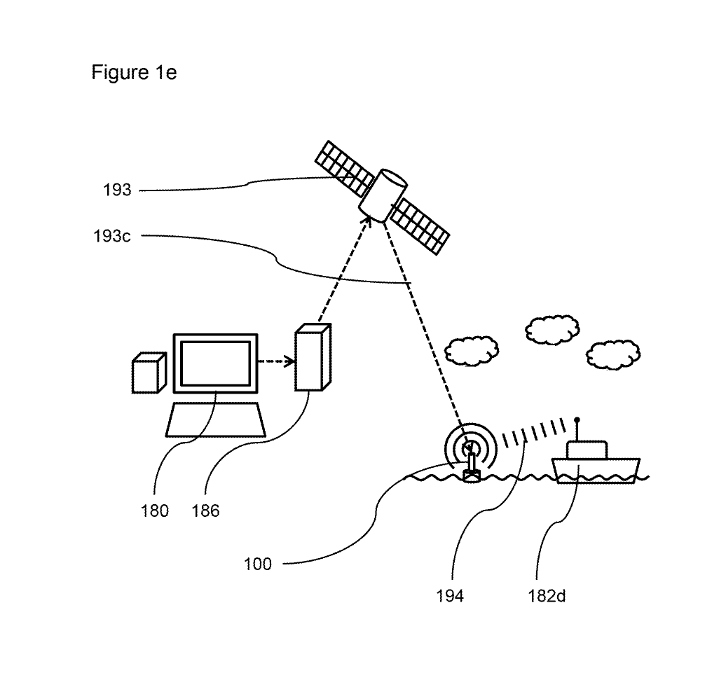

FIG. 1a depicts an embodiment of a maritime beacon 100 comprising:

a controller 155;

a bidirectional communications transceiver 151 in communication with the controller;

a broadcast alert signal generator 153 in communication with the controller;

wherein the controller is configured to receive configuration commands via the bidirectional communications transceiver and to control the operation of the broadcast alert signal generator based on the received configuration commands.

In this case, the maritime beacon also includes a receiver 152 for communicating with global positioning satellites such as GPS. The beacon may be powered by an onboard battery 154 in this case. The beacon may also be connected to an external asset (e.g. by a pressure-rated pluggable electrical connector) so that it can be powered by the asset while it is connected to the asset. When the beacon is released from the asset to float to the surface or when the beacon and asset stay intact and float to the surface together, the respective power source will power the beacon until the beacon is recovered. It will be appreciated that other embodiments may be powered differently. It will be appreciated that the bidirectional communications transceiver and broadcast alert signal generator are configured to communicate wirelessly.

In this case, the beacon also includes one or more sensors 159 for determining whether the beacon is underwater or whether it is at the surface. In this case, the beacon is not configured to be able to transmit information unless the beacon is at or near the surface. Therefore, energy would be wasted if the transceivers 151, 152 and/or the broadcast alert generator were activated deep underwater. Therefore, in this embodiment, the beacon is configured to determine when the beacon has resurfaced and to enable activation of the transceivers 151, 152 and/or the broadcast alert generator in response to that determination.

The controller 155 in this case includes a processor (e.g. a central processing unit, a microprocessor, an application-specific integrated circuit or ASIC or a multicore processor). The controller in this case also comprise memory 156 (e.g. flash memory, a hard-drive, volatile memory). The controller in this case is configured to run computer program code 157 (e.g. stored on the memory 156) configured to allow a controller 155 to adjust the configuration of the beacon based on a predetermined program and/or commands based on information received from the sensors and/or one or more of the communications transceivers/antennae. The computer program code may be stored on a non-transitory medium such as a CD, DVD, USB or Cloud-based services.

In this case, as shown in FIG. 1b, the beacon 100 is initially attached to an underwater asset 190 such as a Remotely Operated underwater Vehicle (ROV), an Autonomous Underwater Vehicle (AUV), and/or scientific equipment. Underwater assets and the associated beacon may be configured to be underwater for extended periods of time (e.g. several years) in remote locations.

The beacon 100 and/or asset 190 and beacon combination may be configured to resurface in response to predetermined conditions. For example, if the asset malfunctions, power goes below a predetermined threshold, or after a predetermined period of time the beacon may resurface to allow the asset to be recovered.

In this case, the beacon 100 is configured to be released from the asset 190 and float to the surface 191 as shown in FIG. 1c. The beacon is configured to detect when it reaches the surface using a surface detector 159 (e.g. a pressure sensor, an optical sensor, or a conductivity measuring device). As noted above, in other cases, the beacon and asset would float to the surface together.

In response to resurfacing, the beacon determines its location. The location information in this case is derived by an on-board GPS 152. That is, the beacon comprises a location system for determining the beacon location based on signals 192a received from a satellite-based 192 positioning system (e.g. GPS).

In this case, the on-board GPS 152 is configured to be activated in response to resurfacing and to interact with GPS satellites 192 to determine its position. This determined position is sent to the controller 155 and then transmitted through the bidirectional communication transceiver 151. In this case, the bidirectional communication transceiver 151 is configured to transmit 193a the information via a communications satellite 193 (e.g. Iridium) to a remote device. In this case, the beacon controller also stores an ID which is transmitted via the bidirectional communication transceiver 151. In this case, the bidirectional communication transceiver 151 is configured to transmit information to a remote device in response to the maritime beacon resurfacing.

Before resurfacing, the beacon in this case remains asleep in a low power or off mode while submerged in the depths of the ocean. Upon detecting that it has reached the surface, it initiates communications to tell the owner or user that it has surfaced and where it is. Now that the bidirectional communications link 193a,b,c is available, the owner can send it instructions on what to do about turning on, in this case, the broadcast alert generator 153 (which may include a radio signal generator (e.g. AIS) and/or a flasher (Audiovisual)) and the rate of recurrence or schedule to save power. The owner or user may not be in close proximity of the beacon at the time it initiated contact so it may need time to get to the general location and then turn on the other location means when close, so that it can be picked up, processed and redeployed.

In this case, the transmitted information 193a includes location information derived from the global positioning system and the beacon ID which is transmitted to a remote computer 180 via a subsystem and gateway 186. Since the owner or user may have more than one device deployed in the ocean, it may be important to be able to identify which one has resurfaced (e.g. in case they need special ships, personnel or equipment to meet it). In other embodiments, the beacon may simply provide a notification upon resurfacing. If the user has a limited number of beacons and they know the location of their assets, this may be enough to mount a recovery operation. That is, the notification may not include data relating to the identity or the location of the beacon.

The remote computer 180 receives the transmitted information and can identify the beacon (and possibly an asset associated with the beacon) from the ID, its location from the GPS determination, and a time of resurfacing (e.g. based on the time of receipt of the transmission or from information encoded into the transmission).

As shown in FIG. 1d, this information may be displayed on the remote computer. In this embodiment, the information is displayed graphically, showing the coast 185, the position of the newly resurfaced beacon and its ID 183. The graphic display also shows the position of vessels in the area, some of which 182a-d may be under the control of the owner or user, and some of which 181 may not. In addition, it will be appreciated that vessels which have the capability of recovering the beacon and/or asset may be distinguished from those which do not have this capability. The graphic display also provides a measure of the range 184 of the beacons broadcast signal generator. This provides a visual indication that there are no vessels within range of the broadcast signal generator.

Using this information at the remote computer 180, a determination can be made whether there are any appropriate vehicles in the vicinity which can recover the beacon and/or associated asset. This may be performed automatically by the remote computer using the current or recent positions of appropriate vehicles within the area of the location transmitted by the resurfaced beacon. Appropriate vehicles in this case may include vessels or ships owned or controlled by the same company at sea and/or vessels owned or controlled by the company at a nearby launching site (e.g. port). It may also include airborne vehicles such as unmanned aerial vehicles and/or helicopters.

The remote computer may then control the device by sending a transmission to the bidirectional communications transceiver 151 which includes configuration commands. For example, if there are vessels in the area, the configuration commands may include a command to turn on the broadcast alert signal generator. In this case, the broadcast alert signal generator comprises a broadcast antenna configured to broadcast location information.

In contrast, if it is determined that there are no appropriate vessels in the vicinity of the beacon, the remote device may be configured to delay activating the broadcast alert signal generator. This can be achieved in a number of ways:
1. The remote computer may transmit configuration commands specifying a delay period after which the broadcast alert signal generator is activated;
2. The remote computer may delay transmitting configuration commands (but may transmit a “message received” confirmation); or
3. The remote computer may transmit configuration commands specifying that the broadcast alert signal generator is deactivated until further configuration commands are received.

In this case, there are no vessels in the area so the remote computer sends a “message received” confirmation 193b but delays transmitting configuration commands until the recovery vessel are within range. By not activating the broadcast alert signal generator energy may be conserved. As noted above, in this case, the beacon is powered by an on-board battery 154 so the energy reserves are limited. In addition, not activating the broadcast alert signal generator reduces the likelihood that another vessel 181 can identify the beacon and/or associated asset.

In this case, the beacon 100 is configured to activate the broadcast alert signal generator 153 in a predetermined default mode in response to determining that bidirectional communications via the bidirectional communications transceiver 151 is unresponsive. In this case, the beacon 100 is configured to wait a pre-determined period of time (e.g. 5 minutes-1 hour). If the “message received” confirmation is not received from the remote computer, the beacon is configured to determine that the bidirectional communications is unresponsive. Likewise, if the bidirectional communications transceiver 151 itself has malfunctioned (e.g. detected using onboard self-diagnostics), the beacon may be configured to enter a predetermined default mode.

In this case, the beacon default mode comprises emitting a broadcast alert signal at a predetermined rate of recurrence (or cycling rate). This predetermined rate of recurrence may decrease with time to prolong battery life in the event that the beacon is not recovered promptly.

In normal operation, as shown in FIG. 1c, the beacon is configured to receive the “message received” confirmation 193b and the broadcast alert signal generator 153 is not activated.

After a period of time, when a vessel 182d is within range 184 of the broadcast alert signal, the remote computer is configured to send configuration commands 193c as shown in FIG. 1e. These configuration commands 193c are configured to activate the broadcast alert signal generator 153.

In this case, the broadcast alert signal generator 153 is a broadcast antenna configured to transmit automatic identification system (AIS) information. The beacon in this case is also configured to transmit the beacon ID on the private bidirectional channel 193a and on the broadcast 194 (AIS). It will be appreciated that, in other embodiments the ID may not be transmitted in the broadcast. Similarly, the location information may not be encoded within the broadcast. That is, in some embodiments, the beacon may be located using the direction from which the radio information is received (e.g. using a phased array antenna detector).

It will be appreciated that the beacon may have more than one ID. For example, it may have a first ID for use with the bidirectional communication system, e.g. an IMEI# (International Mobile Equipment Identity Number) which is the unique ID of the Iridium transceiver. The broadcast antenna (e.g. AIS) may have its own unique ID related to its specific operation. These separate IDs would be associated together by the beacon and/or the remote computer. In addition, the system may allow the user to give the device a user-friendly name like “Dave #1, Atlantic Ocean” or “OSB6” which would be associated with one or more of the device IDs so the owner/user would see a familiar name pop up on the screen.

In other embodiments the broadcast alert signal generator is configured to generate audiovisual alerts signals. For example, the broadcast alert signal generator may comprise lights (e.g. an LED array) and/or speakers instead of or in addition to the broadcast radio antenna.

In other embodiments, the beacon may be configured to connect to an external power source (e.g. within a connected asset) and/or use a renewable power source (e.g. solar, wave and/or wind power generator).

The configuration commands may be configured to control the broadcast alert signal generator to emit signals in a particular pattern.

It will be appreciated that the remote computer may also be in communications with the vessel 182d which is recovering the beacon so that the vessel can have information on the configuration commands provided to the beacon so that the vessel can configure its detectors to the signals which are being emitted by the broadcast signal generator.

### Process Steps

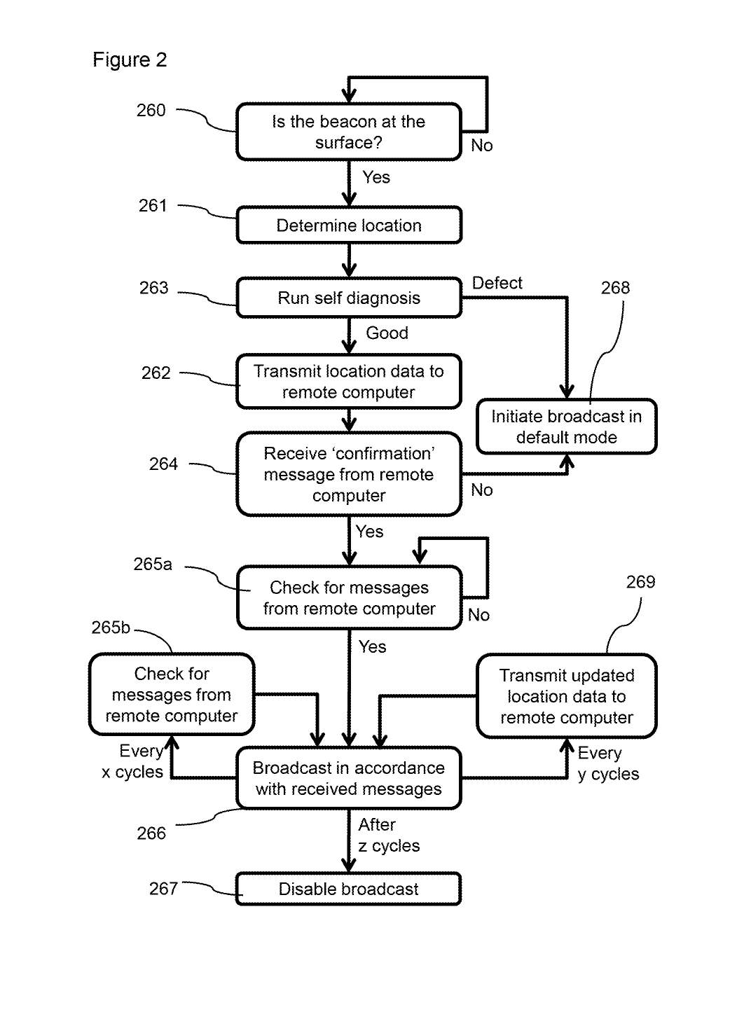

It will be appreciated that the beacon may stay deeply submerged on, for example, the ocean floor possibly for extended periods of time. During this time it may be powered by internal batteries and/or a host device (e.g. a connected asset). The process of one embodiment of the present disclosure is shown in FIG. 2. It will be appreciated that in other embodiments some of the steps shown in FIG. 2 may be omitted or carried out in a different order. For example, some embodiments may not have a self diagnosis program or carry out a self diagnosis first upon resurfacing or after attempting to send information to the remote computer and in response to not receiving a confirmation message.

It will be appreciated that periodically the beacon may determine 260 whether or not it is at the surface.

The beacon comes to surface by itself (e.g. unintentionally or unknowingly) or intentionally (e.g. according to a predetermined program or in response to release by a user or owner). The release resurfacing of the beacon may be planned or unplanned.

Once the beacon detects that it is at the surface a communication process is initiated. In this case, this involves that beacon getting 261 Location Data from a Satellite System (GPS). At this stage, the broadcast alert signal generator may be maintained in an unactivated mode. For example, there may be no Lights, broadcast (e.g. AIS) or bidirectional communications yet.

Then the beacon may be configured to transmit 262 information from the beacon. This may include the determined location data (and possibly ID Information) using the bidirectional communications transceiver (e.g. Iridium). Again the broadcast alert signal generator may be maintained in an unactivated mode.

The information transmitted by the bidirectional communications transceiver is received by a Bidirectional Radio Communications remote computer. In response the remote computer may transmit back:
An acknowledgement 264; and/or
Instructions for the controller depending on mode—E.g. a Default Automatic mode or Manual Override by Crew/Remote Computer.

The beacon is now in communication with the remote computer and will follow the various modes it is instructed to follow.

If the beacon does not receive the confirmation message or acknowledgement 264 or otherwise determines that bidirectional communications may not be possible (e.g. by self diagnosing a defect with the beacon which would prevent bidirectional communications 263), the beacon may be configured to initiate a broadcast signal in a default mode 268. If the self-diagnosis detects a fault with the broadcast antenna, the beacon may be configured to notify the remote computer via the bidirectional communications transceiver.

It will be appreciated that some embodiments may be configured to conduct one cycle of GPS acquisition then one cycle of Iridium TX/RX or other bidirectional communication cycle (TX is transmitting messages out and RX is a mailbox check to see if any messages are coming to the device 265a). The location information may be used to generate location information for broadcasting using the broadcast antenna (e.g. AIS) or any other location dependent components associated with beacon.

Following the Iridium TX/RX or other bidirectional communications (e.g. if there are new configuration commands), the beacon may be configured to “reboot” and begins cycles of the newly configured behavior.

As noted above, the beacon may be configured to perform a cycle to ensure that the beacon is operating according to the program currently defined by the remote computer and that the remote computer has current status information from the beacon. In every cycle information may be broadcast by the broadcast antenna (e.g. AIS, if enabled by the remote computer) and the GPS updated.

Every x cycles the bidirectional transceiver may poll 265b the remote computer to determine whether there have been new configuration commands issued by the remote computer (e.g. this may include checking the Iridium Mailbox Check). x may be, for example, 1 (i.e. every cycle) or between 10-100. Increasing x can reduce the power consumption due to activating the bidirectional transceiver.

Every y cycles, the bidirectional transceiver may be configured to transmit 269 information to the remote computer (e.g. updated location information). y may be, for example, 1 (i.e. every cycle) or between 10-100. Increasing y can reduce the power consumption due to activating the bidirectional transceiver.

It will be appreciated that the broadcast antenna may be disabled automatically 267 after z total cycles elapse. z may be predetermined or set by sending configuration commands to the beacon. z may be between 5 and 100.

For example, the duration of an AIS cycle is allocated to 6 minutes as per the firmware specification. This includes the dynamic as well as static data transmissions. Dynamic data (position, bearing) is updated every 30 seconds if moving faster than 2 knots, every 3 minutes otherwise. That is, each the cycle may repeat every 10 seconds to 5 minutes. Static Data is sent in two parts every 6 minutes.

The rate of recurrence of the cycle may be predetermined or set by sending configuration commands to the beacon. The rate of recurrence of the cycle may be dependent on the proximity of the recovery vessel (e.g. the rate of recurrence of the cycle may increase as the vessel approaches the location of the beacon) and/or the amount of the power available to the beacon (e.g. the rate of recurrence of the cycle may decrease as the amount of available power remaining decreases).

Although the present technology has been described and illustrated with respect to preferred embodiments and preferred uses thereof, it is not to be so limited since modifications and changes can be made therein which are within the full, intended scope of the disclosure as understood by those skilled in the art.

### RELATED APPLICATIONS

This application claims the benefit of U.S. Provisional Patent Application No. 62/664,391 filed Apr. 30, 2018, which is hereby incorporated by reference in its entirety.

1. A maritime beacon comprising:
a controller;
a bidirectional communications transceiver in communication with the controller;
a broadcast alert signal generator in communication with the controller;
wherein the controller is configured:
to communicate with a remote computer via the bidirectional communications transceiver to transmit notifications to, and to receive configuration commands from, the remote computer; and
to control the operation of the broadcast alert signal generator based on the received configuration commands.

2. The beacon of claim 1, wherein the broadcast alert signal generator comprises a broadcast antenna configured to broadcast location information.

3. The beacon of claim 2 wherein the configuration commands are configured to control one or more of:
when the broadcast antenna is activated;
when the broadcast antenna is deactivated; and
the rate of recurrence of broadcasting location information.

4. The beacon according to claim 1 wherein the bidirectional communication transceiver is configured to transmit information to a remote device in response to the maritime beacon resurfacing after having been underwater.

5. The beacon according to claim 1 wherein the beacon is configured to detect when it reaches the surface using a surface detector.

6. The beacon according to claim 1 wherein the broadcast alert signal generator is configured to generate audiovisual alerts signals.

7. The beacon according to claim 1 wherein the configuration commands are configured to control the broadcast alert signal generator to emit signals in a particular pattern.

8. The beacon according to claim 1 wherein the bidirectional communications transceiver is configured to use satellite communications.

9. The beacon according to claim 2 wherein the broadcast antenna is configured to transmit automatic identification system (AIS) information.

10. The beacon according to claim 2 wherein the broadcast antenna is configured to broadcast radio waves.

11. The beacon according to claim 2 wherein the broadcast antenna is configured to be activated in a predetermined default mode in response to determining that the bidirectional communications transceiver is unresponsive.

12. The beacon according to claim 1 wherein the beacon comprises a location system for determining a location of the beacon based on signals received from a satellite-based positioning system.

13. The beacon according to claim 1 wherein the beacon comprises a battery or a power source connector configured to connect to an external power source.

14. The beacon according to claim 1 wherein the beacon comprises a renewable power source.

15. The beacon according to claim 1, wherein the beacon is configured to transmit an ID to the remote computer via the bidirectional communications transceiver.

16. The beacon according to claim 1, wherein the beacon is configured to transmit location information to the remote computer via the bidirectional communications transceiver.

17. The beacon according to claim 1, wherein the beacon is a submersible beacon.

18. A method for operating a maritime beacon having a bidirectional communications transceiver and a broadcast alert signal generator, the method comprising:
receiving configuration commands via the bidirectional communications transceiver; and
controlling the operation of the broadcast alert signal generator based on the received configuration commands.

19. A system comprising:
one or more beacons according to claim 1; and
a remote computer, wherein the remote computer is configured to receive information from a said bidirectional communications transceiver and to transmit configuration commands to a said beacon.

20. A communications computer comprising:
a controller;
a bidirectional communications transceiver in communication with the controller;
wherein the controller is configured:
to communicate with a maritime beacon via the bidirectional communications transceiver to receive notifications from, and to transmit configuration commands to, the maritime beacon; and
to control the operation of a broadcast alert signal generator of the maritime beacon using the transmitted configuration commands.
